(19) United States
(12) Patent Application Publication
(10) Pub. No.: US 2022/0035061 A1
(43) Pub. Date: Feb. 3, 2022

(54) THREE-DIMENSIONAL RESISTIVITY PROBE FOR IN-SITU MONITORING

(71) Applicant: First Institute of Oceanography, Ministry of Natural Resources, Laoshan District (CN)

(72) Inventors: Tengfei Fu, Laoshan District (CN); Lei Guo, Laoshan District (CN); Xingyong Xu, Laoshan District (CN); Yanguang Dou, Laoshan District (CN); Wenquan Liu, Laoshan District (CN); Ying Yu, Laoshan District (CN)

(21) Appl. No.: 17/505,414

(22) Filed: Oct. 19, 2021

Related U.S. Application Data
(63) Continuation of application No. 17/093,250, filed on Nov. 9, 2020.

(30) Foreign Application Priority Data
Nov. 26, 2019 (CN) 201911172237.7

(51) Int. Cl. G01V 3/02

(52) U.S. Cl. CPC G01V 3/02

(57) ABSTRACT

The invention provides a three-dimensional resistivity probe for in-situ monitoring comprises: a probe rod body inside which one or more subordinate controllers are provided; a control cabin inside which a main controller is provided disposed at the top of the probe rod body; and a cone tip provided at the bottom of the probe rod body; wherein the probe rod body comprising: a plurality of resistivity sensor modules, wherein each resistivity sensor module including a plurality of insulating rings, each insulating ring having a protruded part at a top end and a groove fitting into at a bottom end, three or more point-electrode grooves are formed at the top end of each insulating ring and two through holes allowing two positioning rods to insert into for assembly are opened thereon and the outer end of each point-electrode groove extends to an outer circumference of each insulating ring. The invention could establish a three-dimensional resistivity dynamic monitoring system, through the three-dimensional resistivity dynamic monitoring system, the transport law and mechanism of water and salt transport, caused by different disaster chain origins, in a special soil body can be revealed, and the water and salt transport spatial distribution dynamic change process in a coastal zone is subjected to high spatial resolution and high precision in-situ long-term monitoring.

### CROSS REFERENCE TO RELATED APPLICATION

This application is a continuation of U.S. application Ser. No. 17/093,250, filed Nov. 9, 2020, which claims priority under 35 U.S.C. § 119 to Chinese Application No. CN201911172237.7, filed, Nov. 26, 2019, the disclosures of which are incorporated herein by reference.

### TECHNICAL FIELD

The invention belongs to the technical field of geological exploration, and particularly relates to a three-dimensional resistivity probe for in-situ monitoring.

### BACKGROUND

Resistivity probe is a sensor to provide a continuous monitoring of resistivity in which from two- to eight metal electrodes may be used on the basis of various measurement techniques, but most of them are categorized as the single-point measurement where electrical characteristics of the object could be monitored for inversion with an arrangement of electrodes or electrode arrays in which an artificial electric field being created. The resistivity probes could be sorted into three types: electromagnetic induction type, electrode type or ultrasonic type, (Zhou Mingjun et al., 2010).

The electrode type is a sensor conducted to measure resistivity by the principle of electrolytic conduction, which is based on an electrochemical method; the electromagnetic induction type is a sensor to measure conductivity of liquids by electromagnetic induction; and the ultrasonic type depends on the variation of ultrasonic waves in liquids. Among them, the electrode type is most widely used.

Won (1987) developed a resistivity measurement system within which four coils are placed on the basis of the Wenner's arrangement which is used to measure the resistivity of seabed sediments. Fossa (1998) developed a resistivity measurement device with coils and plate electrodes which is applied to measure gas-liquid mixtures. Rosenberger (1999) designed and developed a penetrating probe which is free-fall deployed into the sediments in a depth range of 4 meters below the sea floor to measure electrical properties in an uninterrupted way, and establishing correspondence between porosity and thermal conductivity (Jansen et al., 2005). At present, those electrode type sensors are widely used in the field of ocean detection to measure seawater salinity, electrical properties of sediments and the like. A large number of scientific research results and market-oriented products have come out one after another. It turns out those sensors with four electrodes can no longer meet the needs of high-accuracy monitoring, especially for in situ measurement.

High-density resistivity measurement technique is an effective method applying a large number of electrodes arranged in advance following a certain rule to form channels being quickly switched through an electrode switching control circuit to monitor the resistivity of multiple points in one or more solutions. Based on the high-density resistivity measurement technique, a high-density resistivity probe applies ring electrodes arranged at equal intervals along the axis of a rod body to densely monitor resistivity of a large number of points by the electrode switching control circuit and an acquisition system. The measurement principle of the high-density resistivity probe is similar to that of the traditional electrical method, but the spatial density of the data is tens or more times than that of the traditional electrical method. It can directly obtain high-accuracy spatial data for inversion of the spatial composition in terms of varied mediums or different components of the same medium being measured.

Ridd (1992) provides an improvement of the device designed by WON in which a pair of electric current electrodes (transmitting electrodes) and six pairs of voltage electrodes (measuring electrodes) are included to carry out seabed erosion process monitoring experiments. Thomas (2002) further optimized the device designed by Ridd by simplifying the in-situ measurement method and integrating the data acquisition part with the probe. Cassen (2004) solved a series of technical problems on the basis of Ridd's design and invented a resistivity probe consisting of 32 pairs of point electrodes to achieve a continuous rolling measurement.

The current research has been aiming at improving the monitoring accuracy to meet the delicacy of tests but the monitoring probes are still limited to large-scale detection in one-dimensional or two-dimensional space. Two-dimensional detection can only obtain the resistivity of a certain point, by which to determine the salinity change at the location so as to learn whether or not seawater intrusion occurs. But due to the fact that the direction of the intrusion could not be determined, so it fails to meet the dynamic monitoring requirement in a three-dimensional space of the seawater intrusion and salinization of soils disaster chain trigger conditions.

### SUMMARY

In order to solve the problem that the resistivity probes of the prior art are still limited to large-scale detection in one-dimensional or two-dimensional space and fails to meet the delicacy of specific detection, one aspect of the present invention is to provide a three-dimensional resistivity in-situ monitoring probe.

A three-dimensional resistivity probe for in-situ monitoring comprises: a probe rod body inside which one or more subordinate controllers are provided; a control cabin inside which a main controller is provided disposed at the top of the probe rod body; and a cone tip provided at the bottom of the probe rod body; wherein the probe rod body comprising: a plurality of resistivity sensor modules, wherein each resistivity sensor module including a plurality of insulating rings, each insulating ring having a protruded part at a top end and a groove fitting into at a bottom end, three or more point-electrode grooves are formed at the top end of each insulating ring and two through holes allowing two positioning rods to insert into for assembly are opened thereon and the outer end of each point-electrode groove extends to the outer circumference of each insulating ring; a cone-tip connector, wherein two limiting rods configured to assemble the resistivity sensor modules are provided on the top of the cone-tip connector, around which the multiple resistivity sensor modules are disposed; and a cabin connector provided with a terminal electronically connected to the main controller; when assembling, sequentially putting a resistivity sensor module around the two limiting rods one by one and connecting the upper end of the top resistivity sensor module to the main control cabin through the cabin connecter and connecting the lower end of the bottom resistivity sensor module to the cone-tip through the cone-tip connecter.

Further, the protruded part is in the shape of a ring.

Further, the thickness of the insulating ring is 5 mm.

Further, the number of the point-electrode grooves is four.

Further, the insulating ring is made of nylon.

Further, the point-electrode grooves are symmetrically distributed.

Compared with the prior art, the advantages and positive effects of the present invention are:

The present invention comprises a plurality of resistivity sensor modules wherein each resistivity sensor module includes a plurality of insulating rings and three or more point-electrode grooves are formed at the top end of each insulating ring, thereby realizing measurement methods on the basis of different electrode arrangements or electrodes on different layers. Based on the structure disclosed by the present invention, a three-dimensional resistivity dynamic monitoring system could be established. The in-situ monitoring by the three-dimensional resistivity dynamic monitoring system can reveal the movement rules and mechanisms of water and salt movement in soils caused by different disaster chains, and achieve high spatial resolution, high-precision monitoring of the dynamic change process of water and salt movement in the coastal zone.

### BRIEF DESCRIPTION OF THE DRAWINGS

FIG. 1 is an exploded view of a three-dimensional resistivity probe for in-situ monitoring according to an embodiment of the present invention;

FIG. 2 is a schematic diagram of an end cap of the three-dimensional resistivity probe shown in FIG. 1;

FIG. 3 is a schematic diagram of a control cabin of the three-dimensional resistivity probe shown in FIG. 1;

FIG. 4 is a schematic diagram of a cabin connector of the three-dimensional resistivity probe shown in FIG. 1;

FIG. 5 is a schematic diagram of a resistivity sensor module of the three-dimensional resistivity probe shown in FIG. 1;

FIG. 6 is a schematic diagram of a cone-tip connector of the three-dimensional resistivity probe shown in FIG. 1;

FIG. 7 is a schematic diagram of a cone tip of the three-dimensional resistivity probe shown in FIG. 1;

FIG. 8 is a schematic diagram showing the arrangement of an insulating ring and a subordinate controller;

FIG. 9 is a schematic diagram showing the arrangement where multiple insulating rings are provided to form a resistivity sensor module;

FIG. 10 is a schematic diagram showing the arrangement where resistivity sensor modules are provided on the limiting rods;

FIG. 11 shows an attainable detectable zone by a crisscross detection of the three-dimensional resistivity probe and inversion;

FIG. 12 is a schematic diagram showing a measurement with annularly-distributed point electrodes on a horizontal section;

FIG. 13 is a schematic diagram showing a measurement with vertical-equidistant-distributed point electrodes;

FIG. 14 is a schematic diagram showing a scrolling measurement with vertical-equidistant-distributed point electrodes;

FIG. 15 is a schematic diagram showing extension detection with cross-layer vertical-equidistant-distributed point electrodes;

FIG. 16 is a schematic diagram showing a three-dimensional spatial orientation monitoring;

FIG. 17 is a vertical point distribution characteristic diagram according to an embodiment of the present invention;

FIG. 18 is a horizontal point distribution characteristic diagram according to an embodiment of the present invention, wherein N1, N2, N3 and N4 representing the point electrodes and ρ_{N1}, ρ_{N2}, ρ_{N3}, ρ_{N4} representing the measurement points;

FIG. 19 is a distribution diagram of calculation points according to an embodiment of the present invention.

### DETAILED DESCRIPTION OF THE EMBODIMENTS

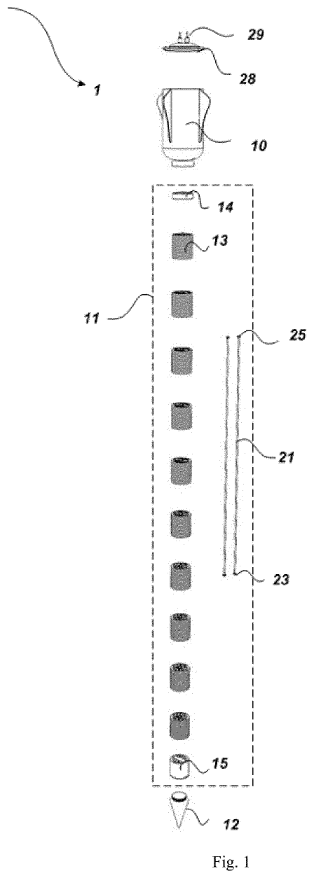

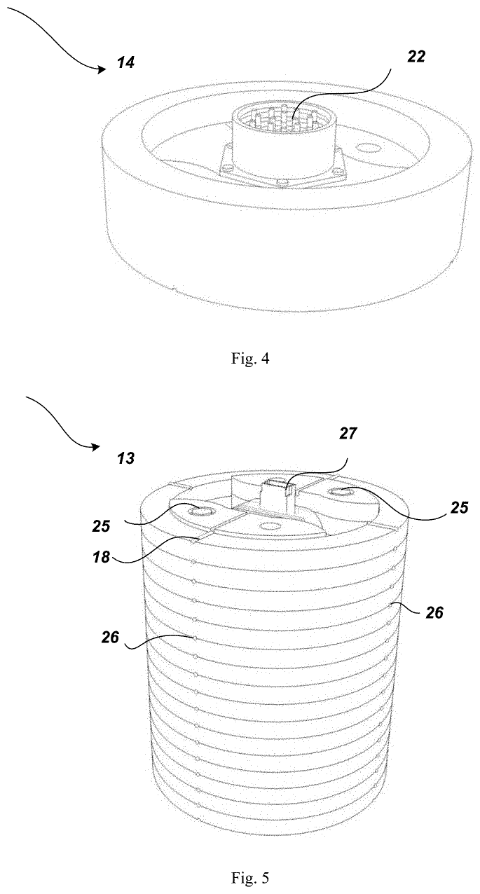

Referring to FIG. 1-7, a three-dimensional resistivity probe for in-situ monitoring is provided, which includes a control cabin 10, a probe rod body 11 and a cone tip 12 from top to bottom.

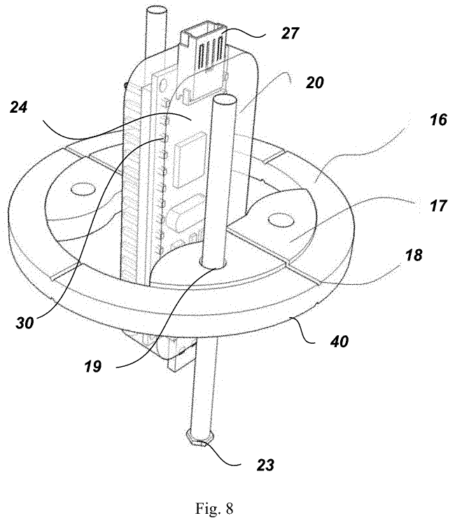

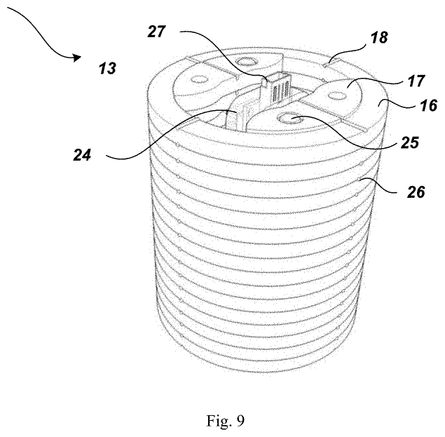

As shown in FIG. 1, the probe rod body 11 adopts a modular assembly structure, which includes multiple resistivity sensor modules 13, a cabin connector 14 and a cone-tip connector 15. Referring to FIG. 8 to FIG. 9, each resistivity sensor module 13 includes a plurality of insulating rings 16 overlapped with each other; each insulating ring 16 has a protruded part 17 at the top end and a groove 40 at the bottom end wherein the protruded part could fit into any groove on the same other insulating ring. Four point-electrode grooves 18 are formed at the top end surface of each insulating ring 16 (also could be six point-electrode grooves or eight point-electrode grooves) and two through holes 19 allowing two positioning rods 20 to insert into are opened thereon. The outer end of each point-electrode groove 18 preferably extends to the outer circumference of each insulating ring 16. Two limiting rods 21 configured to assemble the resistivity sensor modules 13 are provided on the top of the cone-tip connector 15, around which the multiple resistivity sensor modules 13 are disposed. A terminal 22 electronically connected to a main controller which is arranged in the control cabin 10 is provided on the cabin connector 14.

The resistivity sensor module 13, the positioning rods 20 and the limiting rods 21 are made of a material PEEK2000 (reinforced compound of medium-viscosity polyether ether ketone reinforced with 30% fiber) and point electrodes are made of yellow copper or electroplated silver chloride.

As shown in FIG. 8, when assembling a resistivity sensor module 13, screwing nuts 23 at bottom ends of both of the positioning rods 20 to fix a subordinate controller 24 therebetween, then putting the insulating rings 16 provided with point electrodes 26 in the point-electrode grooves 18 around the positioning rods 20 with an arrangement that the insulating rings 16 are overlapped with each other and the outer ends of point-electrode grooves 18 thereon are aligned with, then fastening nuts 25 at the top ends of the positioning rods 20, a resistivity sensor module 13 is assembled as shown in FIG. 9.

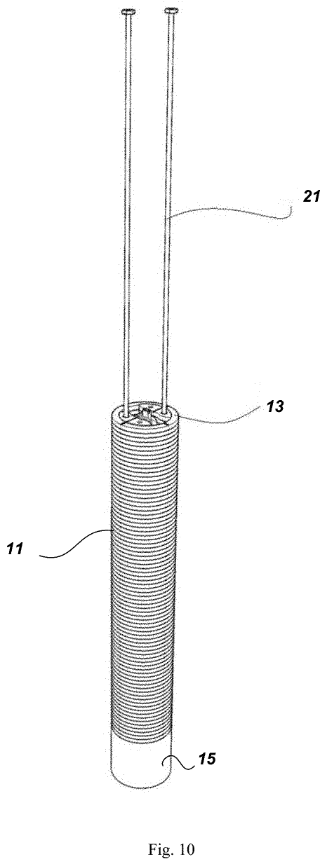

When assembling a three-dimensional resistivity probe, sequentially putting a resistivity sensor module 13 around the two limiting rods 21 one by one, as shown in FIG. 10, and then connecting the upper end of the top resistivity sensor module 13 to the main control cabin 10 through the cabin connecter 14 and connecting the lower end of the bottom resistivity sensor module 13 to the cone-tip 12 through the cone-tip connecter 15, for example, as shown in FIG. 6, a same protruded part 27 could be provided at the top end of the cone-tip connecter 15 which could fit into the groove on the bottom insulating ring 16 of the bottom resistivity sensor module 13 and the cone-tip connecter 15 is screwed on the cone-tip 12.

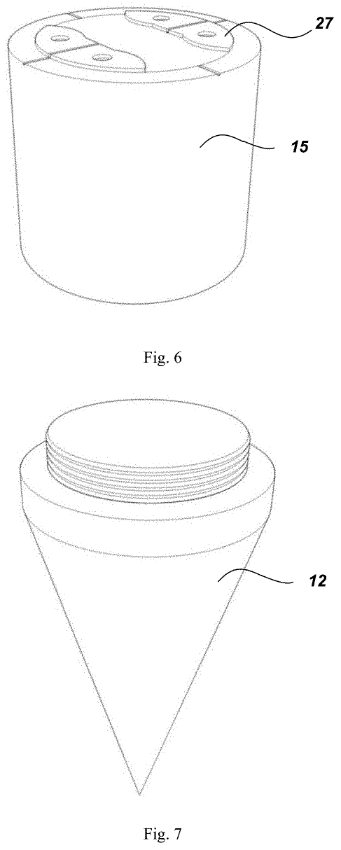

In this embodiment, the outer circumference φ of the main part of the three-dimensional resistivity probe, namely the outer circumference of the probe rod body 11 is 70 mm, and the overall length of the multiple resistivity sensor modules 13 which could be used for measuring the resistivity of the surroundings is preferably set as 800 mm and the total length of the probe is 1200 mm. It is preferably set four point electrodes 26 which are horizontally provided and distributed at an equal interval and vertically aligned with and spaced equidistant from each other at an interval of 5 mm, namely the thickness of the insulating ring is 5 mm, as shown in FIG. 5. Each horizontal section includes 4 point electrodes, if there are 160 insulating rings 16, a total of 160 horizontal sections are vertically distributed so there is a total of 640 point electrodes.

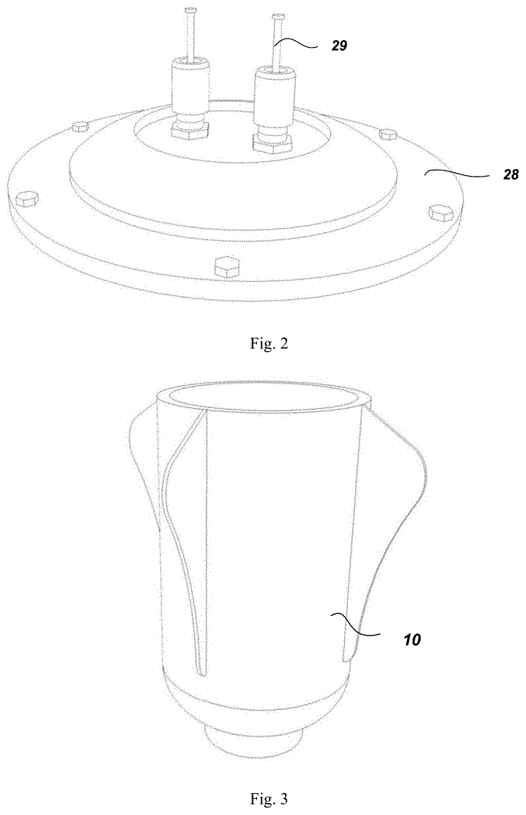

The data acquisition and control of the three-dimensional resistivity in-situ monitoring probe of this embodiment adopts a master-slave model which could be switched flexibly so as to use varied point electrode arrangements for measuring. The main controller within the main cabin 10 includes a data transmission unit, a data storage unit, a process unit, a communication unit, a power supply unit and the like, also an internal independent battery is provided. The main controller could provide a constant current power supply mode (0.01 A/0.1 A/1 A/5 A) and a constant voltage power supply mode (0.1V/0.5V/2V/10V). The main controller is connected to each subordinate controller 24 through a bus structure where a plurality watertight interlock sockets are provided, as an example shown in FIG. 9, USB sockets 27 are respectively provided at the top end and the bottom end of the subordinate controller 24 which could fit into any USB socket 27 of the same subordinate controller 24 and the uppermost USB socket 27 could connected to the main controller through the same socket or other types of bus interface. Additionally, the main controller could communicate with a host computer with reserved watertight connectors 29 provided on an end cover 28, as shown in FIG. 2, so that advanced functions as code modification, real-time communication, data transmission, parameter adjustment and battery charging could be achieved easily.

The preferable length of each resistivity sensor module 13 is 80 mm. Each resistivity sensor module 13 preferably includes sixteen insulating rings 16 and four point electrodes 26 are preferably provided on each horizontal section at the top end of the insulating ring 16. Terminals 30 disposed on the subordinate controller 24 positioned within the probe rod body 11 are respectively connected to the sixty-four point electrodes 26 by electrical wires along the point-electrode grooves 18. The subordinate controller 24 is configured to trigger some of or all point electrodes 26 connected and obtain data. The functions of the subordinate controller 24 include data acquisition, data communication, electrodes switching and the like. As an example, a composite switch could be provided to trigger different point electrodes matrix so as to form different electrode arrangements.

The measurement by the three-dimensional resistivity probe for in-situ monitoring could be performed in different forms.

### Example 1: Measurement with Annularly-Distributed Point Electrodes on Horizontal Section

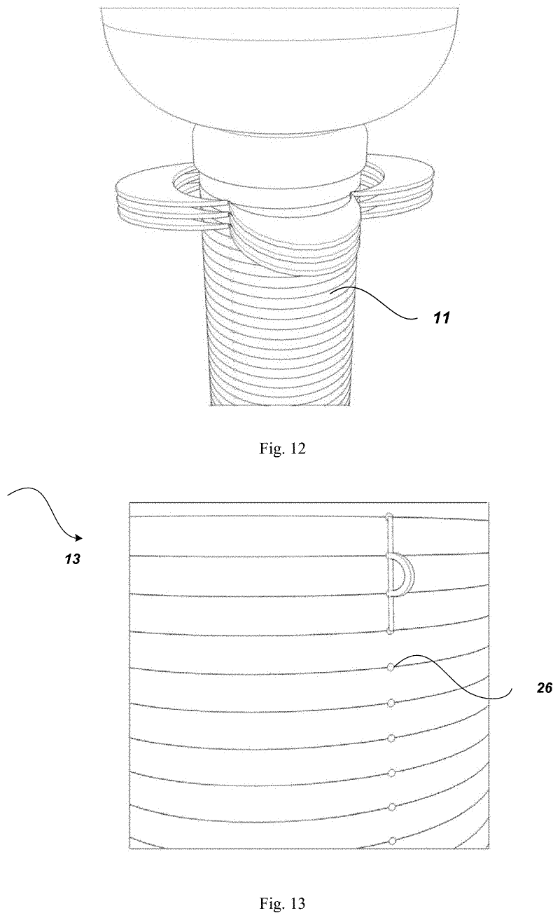

Based on the arrangement of four equidistant annularly-distributed orthogonal point electrodes 26 on one horizontal section, any of two adjacent point electrodes 26 could be electrically triggered to work as a two-pole sensor to determine resistivity between the two pins, and that is to say four measurement points could be obtained in one horizontal section. FIG. 12 shows that in the resistivity probe according to the present invention the two-pole measurement could be performed section by section in turn, in which curved lines represent the range of detectable zone. Taking the sample probe where ten resistivity sensor modules 13 are provided as an example, four measurement points could be obtained in one horizontal section and a collection of 640 resistivity measurement data could be measured at locations close to the probe rod body 11 which are uniformly distributed by the two-pole measurement method, the spatial resolution is 35×2^{0.5}=49.5 mm, and the diameter is 70 mm.

### Example 2: Scrolling Measurement with Vertical-Equidistant-Distributed Point Electrodes

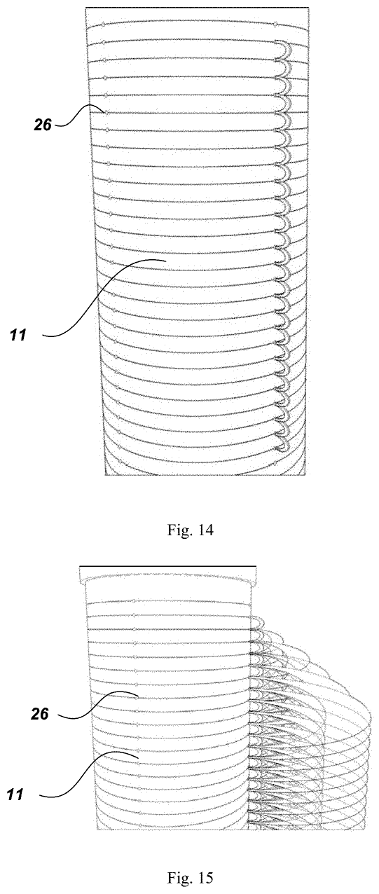

Taking the sample probe within which ten resistivity sensor modules 13 are provided as an example, there are 160 point electrodes 26 which are vertically spaced equidistant from each other and aligned with in a line. Any of four adjacent point electrodes 26 could be electrically triggered to work as a four-pole sensor on the basis of the Wenner method. FIG. 13 shows that in the resistivity probe according to the present invention the four-pole measurement could be performed as the movement of scrolling, in which curved lines represent the range of detectable zone. The scrolling measurement means that the top four adjacent point electrodes in line could be electrically triggered at first to work as a four-pole sensor, then the second to the fifth adjacent point electrodes and the rest could be done in the same manner from the top to bottom. The spatial resolution is 5 mm and 157 measurement points could be obtained along each vertical line, shown in FIG. 13 and FIG. 14.

### Example 3: Extension Detection with Cross-Layer Vertical-Equidistant-Distributed Point Electrodes

Taking the probe according to the present invention within which ten resistivity sensor modules 13 are provided as an example, there are 160 point electrodes 26 which are spaced equidistant from and aligned with each other in a line. FIG. 15 shows that any of four point electrodes 26 on different layers with same vertical spacing between any of two could be triggered to work as a four-pole sensor with a larger spacing than that of the Example 2 based on the Wenner method, in which curved lines represent the range of detectable zone. With this arrangement, the number of point electrodes p=160 and the number of measurable layers N=(P−1)/3=53, the available point electrodes on a lower layer decreasing from the preceding one by three so the tolerance d=−3. For the first layer, N=1, the available measurement points a₁=160−1−2N=157; for the 53th layer, the available measurement points a₅₃=a₁+(N−1)×d=157+53×(−3)=1, and there are a collection of

$${S}_{53} = N \times {a}_{1} + \frac{N ( N - 1 )}{2} \times d = 53 \times 157 + \frac{53 \times 52}{2} \times ( - 3 ) = 4187$$

point detection data could be obtained. For those measurement points on the Nth layer, the spatial resolution is 5 mm×N (N≤40), the horizontal measurement range is 0.5×(5 mm×N).

### Example 4: Spatial Orientation Detection with Point Electrodes

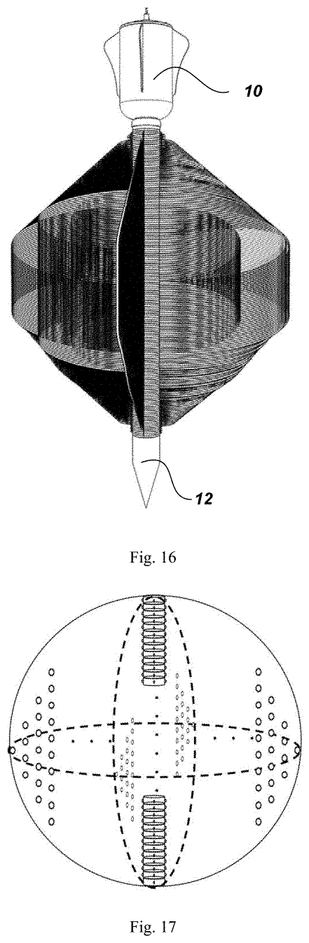

Based on high-density spatial arrangement of point electrodes of the three-dimensional resistivity probe for in-situ monitoring according to the present invention, a three-dimensional spatial orientation monitoring could be realized, which is shown in FIG. 16, by sequentially performing scrolling measurement with vertical-equidistant-distributed point electrodes in four orthogonal directions, which is explained in Example 2 and extension detection with cross-layer vertical-equidistant-distributed point electrodes, which is explained in Example 3 in four orthogonal directions.

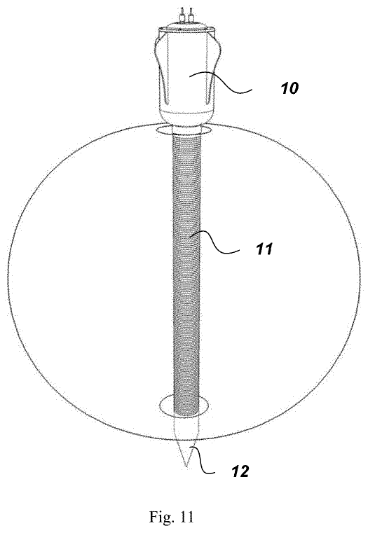

By integrating those measurement data acquired by the three-dimensional resistivity probe for in-situ monitoring according to the present invention, spatial interpolation could be performed to obtain complete spatial detection data and further infers that the spatial distribution of the resistivity detectable zone obtained is a regular ellipsoid, as shown in FIG. 11. Within the detectable zone, the closer to the probe rod body in a horizontal manner, the higher the spatial resolution. Hence, a spatial resistivity cross-inversion suitable for the three-dimensional resistivity probe could be established to invert the spatial distribution of resistivity and accurately obtain the dynamic process of spatial distribution of water and salt transport.

The specific process is illustrated as follows:

In the three-dimensional resistivity probe according to the present invention, each horizontal section includes 4 point electrodes 26 and a total of 160 horizontal sections are vertically distributed so there is a total of 640 point electrodes 26.

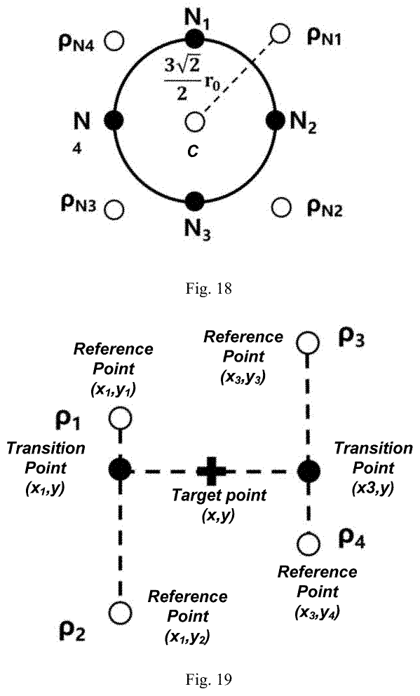

The resistivity measurement points acquired by the three-dimensional resistivity probe could be relied on its vertical arrangement, which is explained in the Example 2 and Example 3 and its horizontal arrangement, which is explained in the Example 1. With the vertical arrangement, four point electrodes 26 at equal distances that the typical spacing is commensurate with n times the distance between two point electrodes could be randomly selected to measure resistivity on the basis of Wenner method. To be specific, within the four selected point electrodes 26, the uppermost point electrode is used as the transmitting electrode, the lowermost point electrode is used as the receiving electrode, and the two middle point electrodes are used as the measurement electrodes. In this way, there are 157 resistivity detection points at one side of the three-dimensional resistivity probe, and also on the other three sides of it, there are 157 points of resistivity detection points on each side. With the horizontal arrangement, four point electrodes are distributed orthogonally in each section. The two-pole method is used to detect the resistivity between any of two adjacent point electrodes, and the resistivity of one point between the two pins could be obtained and four point data could be measured within one section. If there are 160 horizontal sections, there will be 640 measurement points. As a whole, for a three-dimensional resistivity probe according to the present invention merely based on the detection examples explained in Example 1 and Example 2, there will be 157×4+640=1268 points where the resistivity could be measured contained in a sphere from a spatial point of view. The distribution characteristics are shown in FIG. 17 and FIG. 18.

Within the sphere space, the resistivity data of the 1268 points could be collected, the following method can be applied to calculate the resistivity value of any point in the sphere space:

1. selecting four reference points where the resistivity data are measured surrounding a target point, preferably with the closet distance, shown in FIG. 19 wherein ρ(x,y) representing the resistivity of the target point (x,y) where the resistivity to be calculated, ρ(x₁,y) and ρ(x₃,y) representing the resistivity of two transition points (x₁,y), (x₃,y), ρ₁(x₁,y₁), ρ₂(x₁,y₂), ρ₃(x₃,y₃), ρ₄(x₃,y₄) representing the resistivity of four reference points (x₁,y₁), (x₁,y₂), (x₃,y₃) and (x₃,y₄) where the resistivity data are measured;

2. calculating the resistivity of the two transition points

$${ρ}_{( {x}_{1} , y )} = {ρ}_{1} \pm \vert {ρ}_{1} - {ρ}_{2} \vert \frac{\vert {y}_{1} - y \vert}{\vert {y}_{1} - {y}_{2} \vert} ; {ρ}_{( {x}_{3} , y )} = {ρ}_{3} \pm \vert {ρ}_{3} - {ρ}_{4} \vert \frac{\vert {y}_{3} - y \vert}{\vert {y}_{3} - {y}_{4} \vert}$$

When ρ1>ρ2, “±” in the formula takes the minus sign, otherwise, it takes the plus sign; when ρ>ρ4, “±” in the formula takes the minus sign, otherwise, it takes the plus sign;
3. calculating the resistivity of the target point on the basis of the resistivity of the two transition points

$${ρ}_{( x , y )} = {ρ}_{( {x}_{1} , y )} \pm \vert {ρ}_{( {x}_{1} , y )} - {ρ}_{( {x}_{3} , y )} \vert \frac{\vert {x}_{1} - x \vert}{\vert {x}_{1} - {x}_{3} \vert}$$

Whenρ (x1, y)>ρ (x3, y), “±” in the formula takes the minus sign, otherwise, it takes the plus sign.

The above description is only the preferred embodiment of the present invention, and is not intended to limit the present invention in other forms. Any person skilled in the art may use the disclosed technical content to modify or modify the equivalent. The embodiments are applied to other fields, but any simple modifications, equivalent changes, and modifications made to the above embodiments according to the technical essence of the present invention without departing from the technical solution of the present invention still belong to the protection scope of the technical solutions of the present invention.

1. A three-dimensional resistivity probe for in-situ monitoring comprises:
a probe rod body inside which one or more subordinate controllers are provided;
a control cabin inside which a main controller is provided disposed at the top of the probe rod body; and
a cone tip provided at the bottom of the probe rod body;
wherein the probe rod body comprising:
a plurality of resistivity sensor modules, wherein each resistivity sensor module including a plurality of insulating rings, each insulating ring having a protruded part at a top end and a groove fitting into at a bottom end, three or more point-electrode grooves are formed at the top end of each insulating ring and two through holes allowing two positioning rods to insert into for assembly are opened thereon and the outer end of each point-electrode groove extends to an outer circumference of each insulating ring;
a plurality of point electrodes, each of the point electrodes being positioned in a point-electrode groove, respectively;
a cone-tip connector, wherein two limiting rods configured to assemble the resistivity sensor modules are provided on the top, around which the multiple resistivity sensor modules are disposed; and
a cabin connector provided with a terminal electronically connected to the main controller;
wherein the resistivity probe is assembled by sequentially putting the resistivity sensor modules around the two limiting rods one by one and connecting an upper end of a top resistivity sensor module to the main control cabin through the cabin connecter and connecting a lower end of a bottom resistivity sensor module to the cone-tip through the cone-tip connecter,
and wherein the three-dimensional resistivity probe provides three-dimensional measurements in different forms based upon which point electrodes of the plurality of point electrodes in the probe rod body are used to generate the three-dimensional measurements.

2. The three-dimensional resistivity probe for in-situ monitoring according to claim 1, wherein the protruded part is in the shape of a ring.

3. The three-dimensional resistivity probe for in-situ monitoring according to claim 1, wherein the thickness of the insulating ring is 5 mm.

4. The three-dimensional resistivity probe for in-situ monitoring according to claim 1, wherein the number of the point-electrode grooves is four.

5. The three-dimensional resistivity probe for in-situ monitoring according to claim 1, wherein the insulating ring is made of nylon.

6. The three-dimensional resistivity probe for in-situ monitoring according to claim 1, wherein the point-electrode grooves are symmetrically distributed.

7. The three-dimensional resistivity probe for in-situ monitoring according to claim 1, wherein each insulating ring comprises four point electrode grooves, and four point electrodes positioned therein.

8. The three-dimensional resistivity probe for in-situ monitoring according to claim 1, wherein the three-dimensional measurements comprise measurement data acquired from point electrodes that are annularly-distributed in the rod body.

9. The three-dimensional resistivity probe for in-situ monitoring according to claim 1, wherein the three-dimensional measurements comprise measurement data acquired from point electrodes that are vertical-equidistant-distributed in the rod body.

10. The three-dimensional resistivity probe for in-situ monitoring according to claim 1, wherein the three-dimensional measurements comprise measurement data acquired from point electrodes that are cross-layer vertical-equidistant-distributed in the rod body.

11. The three-dimensional resistivity probe for in-situ monitoring according to claim 1, wherein the three-dimensional measurements comprise measurement data acquired from high-density spatially arranged point electrodes in the rod body.

12. The three-dimensional resistivity probe for in-situ monitoring according to claim 1, wherein the terminal of the cabin connector is configured to slidably insert into an accommodating terminal of the main controller.
